(19) United States
(12) Patent Application Publication
(10) Pub. No.: US 2018/0191063 A1
(43) Pub. Date: Jul. 5, 2018

(54) ANTENNA STRUCTURE AND ELECTRONIC DEVICE

(71) Applicant: Asahi Glass Company, Limited, Chiyoda-ku (JP)

(72) Inventors: Ryuta SONODA, Chiyoda-ku (JP); Koji Ikawa, Chiyoda-ku (JP); Toshiki Sayama, Chiyoda-ku (JP)

(73) Assignee: Asahi Glass Company, Limited, Chiyoda-ku (JP)

(21) Appl. No.: 15/905,307

(22) Filed: Feb. 26, 2018

Related U.S. Application Data
(63) Continuation of application No. PCT/JP2016/074470, filed on Aug. 23, 2016.

(30) Foreign Application Priority Data
Sep. 1, 2015 (JP) 2015-172383

(51) Int. Cl. H01Q 1/48; H01Q 9/04; H01Q 1/24

(52) U.S. Cl. CPC H01Q 1/48; G02B 6/0088; H01Q 1/243; H01Q 9/0457

(57) ABSTRACT

An antenna structure includes a radiating element; a power feeding element configured to feed power to the radiating element in a noncontact manner; a backlight chassis, on which a light source for generating light is attached, a liquid crystal panel being irradiated with the light; and a transmission line conductably connected to the backlight chassis, the power feeding element being connected to an end of the transmission line.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2016/074470 filed on Aug. 23, 2016 and designating the U.S., which claims priority of Japanese Patent Application No. 2015-172383 filed on Sep. 1, 2015. The entire contents of the foregoing applications are incorporated herein by reference.

### BACKGROUND OF THE INVENTION

### 1. Field of the Invention

The disclosure herein generally relates to an antenna structure and an electronic device.

### 2. Description of the Related Art

Conventionally, portable information devices, in which antenna substrates provided with chip antennas and ground patterns are arranged on rear surfaces of liquid crystal panels so that the chip antennas are located in upper portions of the liquid crystal panels, have been known (e.g. See Japanese Unexamined Patent Application Publication No. 2002-73210). Japanese Unexamined Patent Application Publication No. 2002-73210 discloses that according to the arrangement of the chip antennas, radiation characteristics on the display surface side and on the rear surface side of the liquid crystal panel can be made unbiased and that a thickness of a display unit including the liquid crystal panel can be decreased.

### SUMMARY OF THE INVENTION

### Technical Problem

However, because the aforementioned related art requires an antenna substrate on which a ground is arranged, a size of an antenna structure is difficult to be reduced and a of an electronic device including the antenna structure is difficult to be reduced.

Then, an aspect of the present invention aims at reducing a size of an antenna structure.

### Solution to Problem

According to an aspect of the present invention, an antenna structure including

a radiating element;

a power feeding element for feeding power to the radiating element in a noncontact manner;

a backlight chassis, on which a light source for generating light is attached, a liquid crystal panel being irradiated with the light; and

a transmission line that uses the backlight chassis as a ground,

the power feeding element being connected to a terminal end of the transmission line, is provided.

### Effect of Invention

According to an aspect of the present invention, because the backlight chassis is used as a ground and an antenna substrate on which a ground is arranged becomes unnecessary, a size of the antenna structure can be reduced.

### BRIEF DESCRIPTION OF THE DRAWINGS

FIG. 1 is a front view depicting an example of an electronic device provided with an antenna structure;

FIG. 2 is a cross sectional view cut along a line A-A in FIG. 1;

FIG. 3 is an enlarged view of a part of the cross sectional view in FIG. 2;

FIG. 4 is a perspective view depicting a specific example of a power feeding structure;

FIG. 5A is a side view schematically depicting an example of the power feeding structure;

FIG. 5B is a side view schematically depicting another example of the power feeding structure;

FIG. 5C is a side view schematically depicting yet another example of the power feeding structure;

FIG. 5D is a side view schematically depicting still another example of the power feeding structure;

FIG. 5F is a side view schematically depicting yet another example of the power feeding structure;

FIG. 5F is a side view schematically depicting still another example of the power feeding structure;

FIG. 5G is a side view schematically depicting yet another example of the power feeding structure;

FIG. 6 is a perspective view depicting an example of an analysis model of the antenna structure;

FIG. 7 is a front view partially depicting an example of the analysis model illustrated in FIG. 6;

FIG. 8 is a diagram depicting an example of a positional relationship between respective members of the analysis model illustrated in FIG. 6;

FIG. 9 is an S11 characteristic diagram depicting an example of a result of simulation for an S-parameter in the analysis model illustrated in FIG. 6;

FIG. 10 is an S11 characteristic diagram depicting an example of a result of simulation for an S-parameter in a model that is obtained by excluding a radiating element from the analysis model illustrated in FIG. 6;

FIG. 11 is an S11 characteristic diagram depicting an example of a result of simulation for an S-parameter in the analysis model illustrated in FIG. 6 when a length of the radiating element is changed; and
FIG. 12 is an S11 characteristic diagram depicting an example of a result of simulation for an S-parameter in the analysis model illustrated in FIG. 6 when a position of the radiating element is changed.

### DETAILED DESCRIPTION OF THE PREFERRED EMBODIMENTS

In the following, with reference to drawings, embodiments for implementing the present invention will be described.

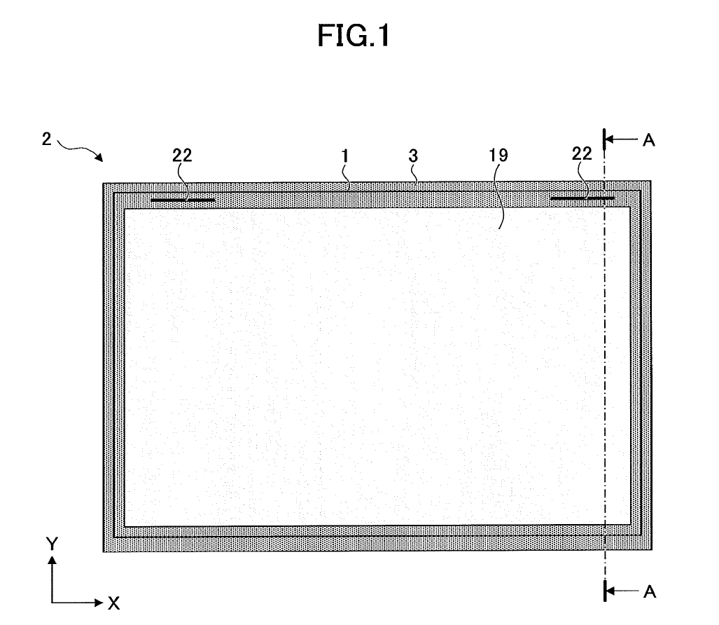

FIG. 1 is a front view depicting an example of an electronic device 2 provided with as antenna structure 1. The electronic device 2 is, for example, a display device such as a stationary type television set and a personal computer, a movable body, or an apparatus installed in a movable body. The movable body specifically includes, for example, a portable mobile terminal apparatus, a vehicle such as a car, a robot, and the like. The mobile terminal apparatus specifically includes an electronic device such as a mobile phone, a smartphone, a computer, a gaming machine, a television set or a music/image player.

The electronic device 2 is provided with a display panel 19 that can display an image, and a frame 3 to which the display panel 19 is fixed. The frame 3 supports the display panel 19 in a state of covering an outer periphery portion of the display panel 19. Moreover, the electronic device 2 is provided with an antenna structure 1 for realizing a wireless communication function with an outside of the electronic device 2. The antenna structure 1 accommodates, for example, a wireless communication standard, such as Bluetooth (registered trademark), or a wireless LAN (Local Area Network) standard such as IEEE 802.11ac.

The antenna structure 1 is provided with a radiating element 22 or a plurality of radiating elements 22. FIG. 1 depicts a configuration in which two radiating elements 22 are arranged on both sides of an upper region of the display panel 19. Note that in order to improve a visibility of the antenna structure 1 in the figure, for the sake of simplicity, in FIG. 1, the antenna structure 1 and the radiating element 22 are indicated with solid lines.

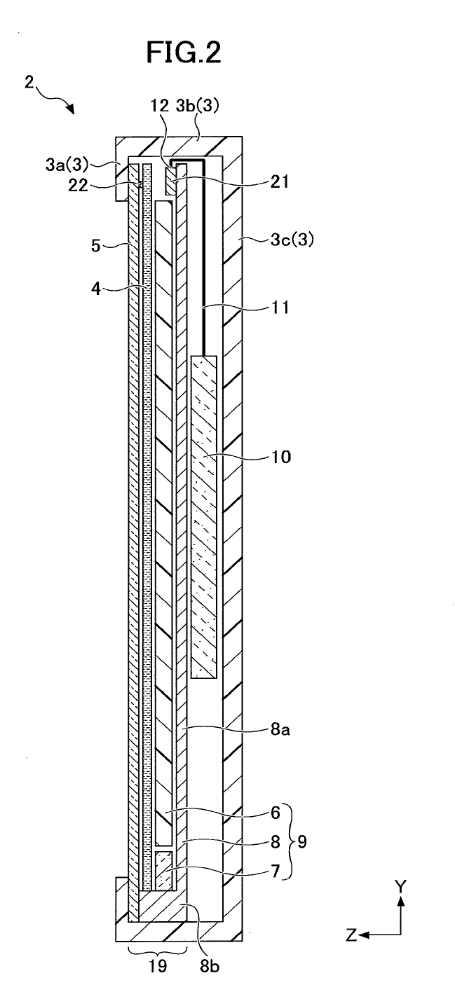

FIG. 2 is a cross-sectional view cut along a line of A-A illustrated in FIG. 1. The frame 3 is a chassis that stores the display panel 19. The frame 3 includes a front surface part 3a forming an opening in which a display surface of the display panel 19 is exposed, a rear surface part 3c opposite to the display surface of the display panel 19 (back surface side), and a side surface part 3b covering an outer periphery side surface of the display panel 19.

The display panel 19 is provided with, for example a liquid crystal panel 4, a front surface panel 5 and a backlight unit 9.

The liquid crystal panel 4 is, for example, a display panel including a pair of glass substrates, and a liquid crystal arranged between the pair of glass substrates.

The front surface panel 5 is a cover panel for covering a display surface of the liquid crystal panel 4. The front surface panel 5 may be a protection panel for protecting the liquid crystal panel 4, or may be a touch panel.

The backlight unit 9 is a panel unit, which is arranged on the rear surface side of the liquid crystal panel 4, and irradiates the liquid crystal panel 4 with light. The backlight unit 9 is, for example an edge type backlight unit provided with a backlight chassis 8, a light source 7 and a light guide plate 6. Moreover. although not shown in figures, the backlight unit 9 includes a diffuser plate or a polarization plate.

The backlight chassis 8 stores the light source 7 and the light guide plate 6 on the liquid crystal panel 4 side. The backlight chassis 8 a member formed from a conductive metal (iron, aluminum or the like) and formed in a shape of box that opens on the liquid crystal panel 4 side. The back light chassis 8 includes a bottom surface part 8a and a side surface part 8b. The backlight chassis 8 has an opening on the liquid crystal panel 4 side.

The light source 7 is an object that generates light with which the liquid crystal panel 4 is irradiated, and attached to the side surface part 8b of the backlight chassis 8. The light source 7 is configured, for example, including a plurality of light emitting elements. The light emitting element specifically includes, for example, an LED (Light Emitting Diode).

The light guide plate 6 is a panel that guides a light from the light source 7 to the liquid crystal panel 4. A light from the light source 7 is incident to the light guide plate the light guide plate 6 outputs the incident light toward the liquid crystal panel 4. The light guide plate 6 is, for example, a member formed from a resin in a shape of a plate.

Note that the backlight unit 9 is not required to be an edge type backlight unit, but may be a directly under type backlight unit. In the case of the directly under type backlight unit, the light guide plate 6 becomes unnecessary, and the light source 7 is attached to the bottom surface part 8a of the backlight chassis 8.

On the rear surface side of the bottom surface part 8a of the backlight chassis 8, a circuit module 10 is arranged. The circuit module 10 includes a reception circuit connected via a transmission line 11 to a power feeding element 21 for feeding power to the radiating element 22 in a noncontact manner. The circuit module 10 may include a driving circuit for driving the light source 7 and the liquid crystal panel 4.

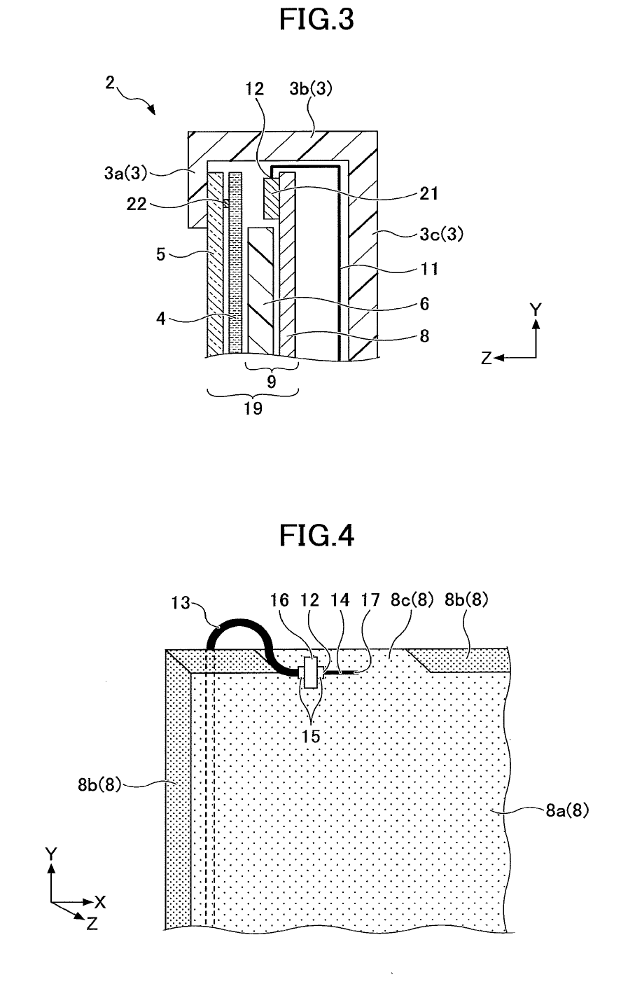

FIG. 3 is an enlarged view of a part of FIG. 2. The antenna structure 1 is provided the transmission line 11, the power feeding element 21, and the radiating element 22.

The transmission line 11 uses the conductive backlight chassis 8 as a ground. The transmission line specifically includes, for example, a coaxial cable, a microstrip line, a strip line, a coplanar waveguide with ground plane (a coplanar waveguide having a ground plane arranged on a surface opposite to a conductor surface on which a signal line is formed), a coplanar strip line, or the like.

The power feeding element 21, is a linear conductor, which is connected to a terminal end 12 of the transmission line 11, and is connected to the radiating element 22 in a noncontact manner to feed power at high frequencies to the radiating element 22. The shape of the power feeding element 21 is not limited to a linear shape as illustrated in FIG. 1, and may be any other shape such as an L shape, a meander shape, or a loop shape.

The radiating element 22 is a linear conductor, which is connected to the power feeding element 21 in a noncontact manner to be fed power at high frequencies from the power feeding element 21, to function as a radiating conductor. The shape of the radiating element 22 is not limited to a linear shape, and may be any other shape such as an L shape, a meander shape, or a loop shape.

The radiating element 22 and the power feeding element 21 may overlap or may not overlap in a planar view from a given direction such as an X-axis direction, a Y-axis direction or a Z-axis direction, as long as the power feeding element 21 and the radiating element 22 are separated from each other by a distance which is enough for feeding power to the radiating element 22 in a noncontact manner.

The power feeding element 21 is arranged on an upper part of the bottom surface part 8a of the backlight chassis 8. The power feeding element 21 may be arranged on a surface of the bottom surface part 8a closer to the liquid crystal panel 4, or may be arranged on a surface of the bottom surface part 8a farther from the liquid crystal panel 4.

The radiating element 22 is arranged on the display surface of the liquid crystal panel 4 in the case of FIG. 2 and FIG. 3. However, the radiating element 22 may be arranged on a back surface of the liquid crystal panel 4, which is opposite to the display surface, or may be arranged inside the liquid crystal panel 4. Alternatively, the radiating element 22 may be arranged on a front surface or a back surface of the front surface panel 5, or may be arranged inside the front surface panel 5. Alternatively, the radiating element 22 may be arranged on the front surface part 3a, the side surface part 3b or the rear surface part 3c of the frame 3. Alternatively, in the case where the front surface panel 5 is a touch panel, the radiating element 22 may be arranged in a sensor unit of the touch panel. Alternatively, the radiating element may be arranged on the light guide plate 6. Alternatively, the radiating element 22 may be arranged on a diffuser plate of the backlight unit 9.

In this way, because the power feeding element 21 is connected to the terminal end 12 of the transmission line 11 that uses the backlight chassis 3 as a ground, it becomes unnecessary to newly arrange an antenna substrate provided with a ground plane. Thus, because the antenna substrate provided with a ground plane becomes unnecessary, a size of the antenna structure 1 can be easily reduced. Moreover, because the size of the antenna structure 1 can be reduced, a size of the electronic device 2 provided with the antenna structure 1 (particularly, reduction in a size of the frame 3) can be easily reduced.

FIG. 4 is a perspective view schematically depicting an example of a power feeding structure in which the power feeding element 21 connected to the terminal end 12 of the transmission line 11 feeds power to the radiating element 22 in a noncontact manner. The coaxial cable 13 is an example of the transmission line 11. A tip of an outer conductor 15 of the coaxial cable 13 (shielded conductor) is an example of the terminal end 12 of the transmission line 11. A core wire 14 exposed from the tip of the outer conductor 15 (inner conductor of the coaxial cable 13) is an example of the power feeding element 21.

A tip 17 of the core wire 14 is an open end. The outer conductor 15 of the coaxial cable 13 is conductably connected to the bottom surface part 8a of the backlight chassis 8 via a connection conductor 16. A cutout portion 8c is arranged in the side surface part 8b of the backlight chassis 8 so that the coaxial cable 13 can be easily wired from the rear surface of the backlight chassis 8 to the front surface of the backlight chassis 8. The coaxial cable 13 passes through the cutout portion cut out of the side surface part 8b, and arranged from the rear surface to the front surface of the bottom surface part 8a. The outer conductor 15 and the core wire 14 of the coaxial cable 13 are arranged in the cutout portion 8c.

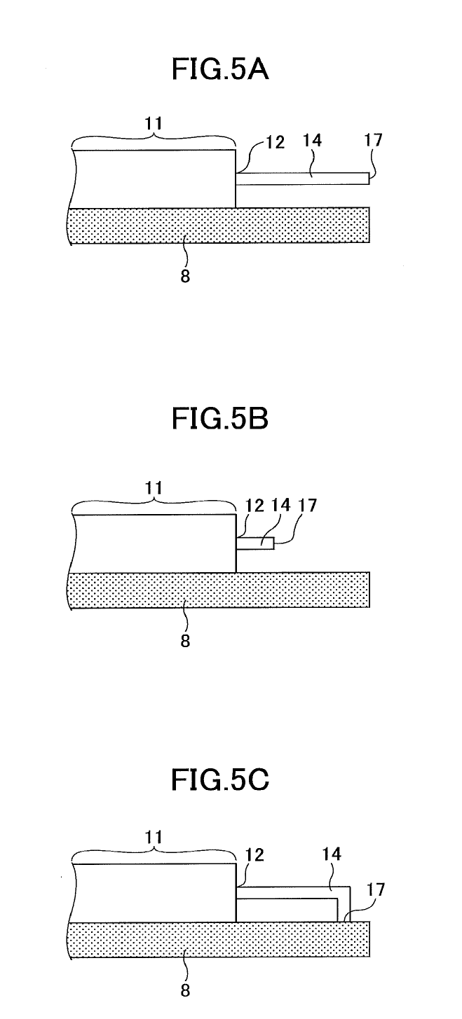

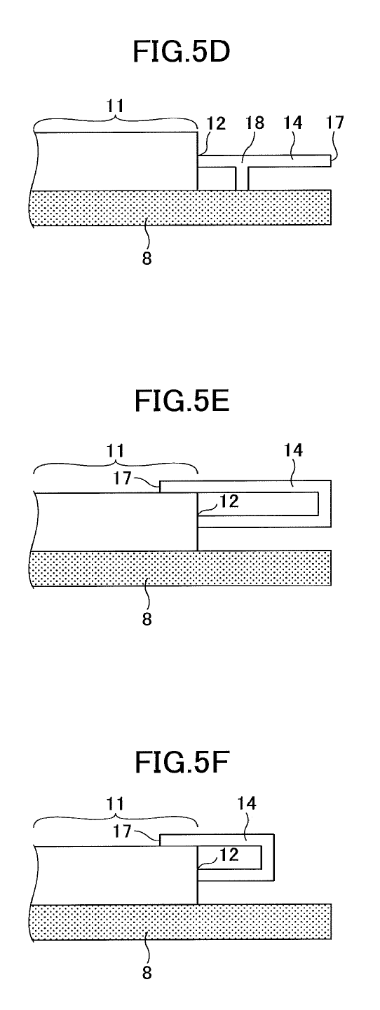

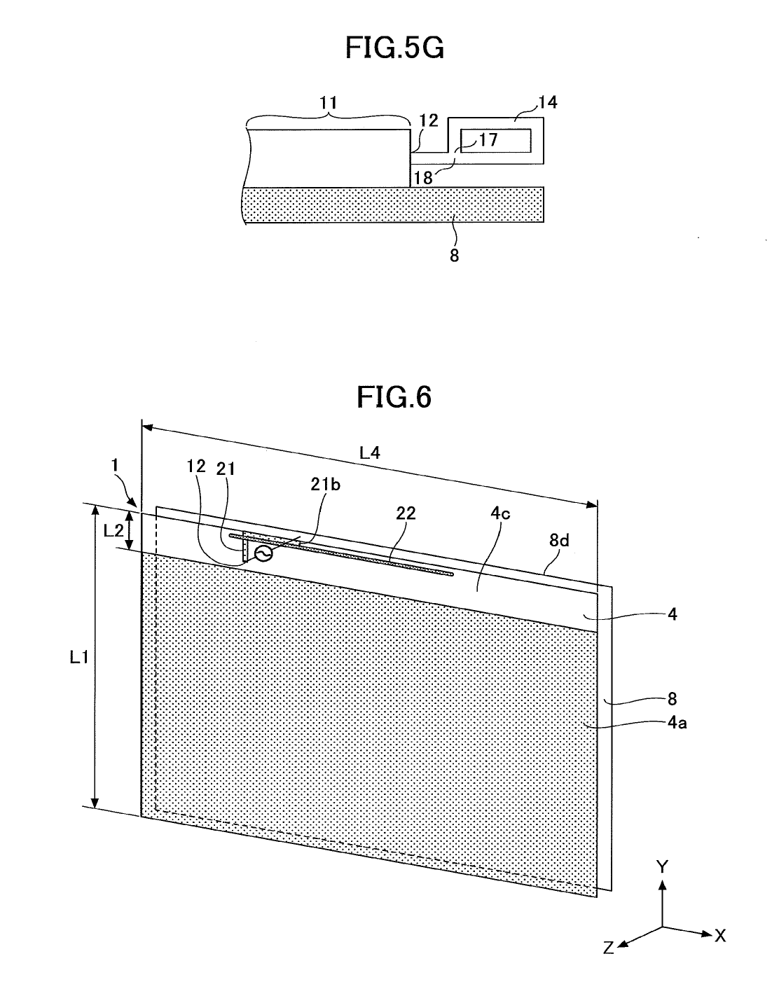

FIGS. 5A to 5G are side views each schematically depicting an example of the power feeding structure in which the power feeding element 21 connected to the terminal end 12 of the transmission line 11 feeds power to the radiating element 22 in a noncontact manner. As an example of the power feeding element 21 connected to the terminal end 12 of the transmission line 11, the core wire 14 that is a conductor part extending from the tip of the outer conductor 15 of the coaxial cable and being exposed is illustrated.

FIGS. 5A and 5B depict configurations in which the tip 17 of the core wipe 14 is an open end. The core wire 14 illustrated in FIG. 5A functions as a monopole antenna, and the core wire 14 illustrated in FIG. 5B functions as a minute monopole antenna in which a distance from the terminal end 12 to the tip 17 is sufficiently small relative to a wavelength. FIG. 5C depicts a configuration in which the tip 17 of the core wire 14 is directly shunted to the backlight chassis 8. FIG. 5D depicts a configuration in which an intermediate portion 18 of the core wire 14 (a part between the terminal end 12 and the tip 17) is directly shunted to the backlight chassis 8. FIGS. 5E and 5F depict loop configurations in which the tip 17 of the core wire 14 is shunted to the outer conductor 15. The core wire 14 illustrated in FIG. 5E functions as a loop antenna. The core wire 14 illustrated, in FIG. 5F functions as a minute monopole antenna in which a distance from the terminal end 12 to the tip 17 is sufficiently small relative to a wavelength. FIG. 5G depicts a loop configuration in which the tip 17 of the core wire 14 is shunted to an intermediate portion 18 of the core wire 14. The core wire 14 illustrated in FIG. 5G functions as a loop antenna.

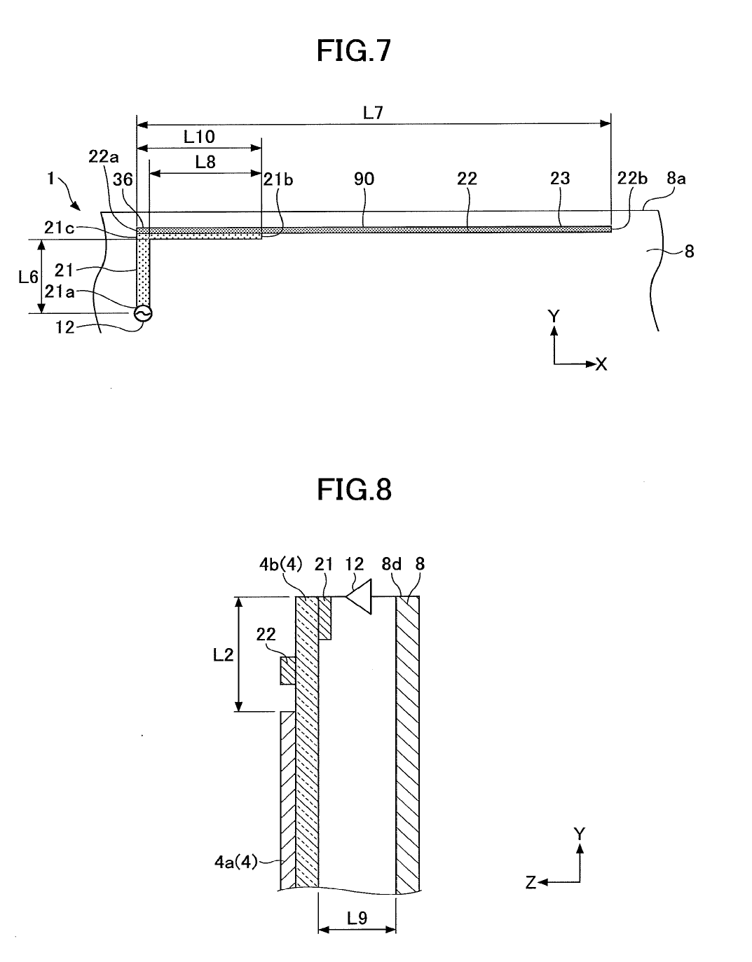

FIG. 6 is a perspective view depicting an example of a simulation model on a computer for analyzing an operation of the antenna structure 1 installed in the electronic device 2. As an electromagnetic field simulator, Microwave Studio (registered trademark) by CST Computer Simulation Technology GmbH, was used. The liquid crystal panel 4 is arranged so as to be opposite the backlight chassis 8. On the liquid crystal panel 4, a conductor surface, on which a signal wiring 4a for driving a thin film transistor is arranged, is formed. FIG. 7 is a front view depicting a part of the analysis model illustrated in FIG. 6 that is partially enlarged.

The power feeding element 21 is a first resonator, for example, connected to the terminal end 12 of the transmission line 11 that uses the backlight chassis 8 as a ground. FIG. 7 depicts an example of a power feeding element 21 formed in an L-shape with a linear conductor extending in a direction that is orthogonal to an outer periphery part 8d of the backlight chassis 8 and that is parallel to the Y-axis, and a linear conductor extending parallel to the outer periphery part 8d and that is parallel to the X-axis. In the case illustrated in FIG. 7, the power feeding element 21 extends in the Y-axis direction from an end portion 21a, with the terminal end 12 as a point of origin, turns to the X-axis direction at a bending portion 21c, and extends in the X-axis direction to a tip portion 21b. The tip portion 21b is an open end to which any other conductor is not connected. FIG. 7 depicts, as an example, the power feeding element 21 having the L-shape. However, the shape of the power feeding element 21 may be any other shape, such as a linear shape, a meander shape, or a loop shape.

The radiating element 23 is arranged in a region on the liquid crystal panel 4 where the signal wiring 4a is not arranged. For example, the radiating element 22 is arranged in a region 4c having a shape of a band or frame that is along an edge of the liquid crystal panel 4.

The radiating element 22 is a second resonator, for example, arranged separated from the power feeding element 21, and functions as a radiating conductor by the power feeding element 21 that resonates. The radiating element 22 is fed power by, for example, an electromagnetic field, coupling to the power feeding element 21, and functions as a radiating conductor.

The radiating element 22 has a conductor part 23 that extends in the X-axis direction along the outer periphery part 8d. The conductor part 23 is arranged separated from the outer periphery part 8d. FIG. 7 depicts an example of the linear radiating element 22. However, the shape of the radiating element 22 may be any other shape, such as an L shape or a meander shape.

According to the conductor part 23 along the outer periphery part 8d included in the radiating element 22, for example, a directivity of the antenna structure 1 can be easily controlled.

The power feeding element 21 and the radiating element 22 are arranged being separated item each other by, for example, a distance with which electromagnetic fields can be coupled to each other. The radiating element 22 includes a power feeding part 36 for receiving power from the power feeding element 21. The radiating element 22 is fed power at the power feeding part 36 via the power feeding element 21 according to the electromagnetic field coupling in a noncontact manner. The radiating element 22, which is fed power in this way, functions as a radiating conductor of the antenna structure 1.

In the case where the radiating element 22 is a linear conductor connecting two points, as illustrated in FIG. 7, the same resonating current as a half wavelength dipole antenna (electric current distributed in a shape of a stationary wave) in formed on the radiating element 22. That is, the radiating element 22 functions as a dipole antenna resonating with a half wavelength of the predetermined frequency (in the following, referred to as a dipole mode).

Moreover, although not illustrated, the radiating element 22 may be a loop shaped conductor such as a linear conductor forming a quadrangle. When the radiating element 22 is a loop shaped conductor, the same resonating current as a loop antenna (electric current distributed in a shape of a stationary wave) is formed on the radiating element 22. That is, the radiating element 22 functions as a loop antenna resonating with a wavelength of the predetermined frequency (in the following, referred to as a loop mode).

Moreover, although not illustrated, the radiating element 22 may be a linear conductor connected to a ground level of the terminal end 12. The ground level of the terminal end 12 is, for example, the backlight chassis 8, or a conductor conductably connected to the backlight chassis 8. For example, an end portion 22b of the radiating element 22 is connected to the outer periphery part 8d of the backlight chassis 8. When the radiating element 22 is a linear conductor in which one end of the radiating element 22 is connected to the ground level of the terminal end 12 and another end is an open end, the same resonating current as a λ/4 monopole antenna (electric current distributed in a shape of a stationary wave) is formed on the radiating element 22. That is, the radiating element 22 functions as a monopole antenna resonating with a quarter of wavelength of the predetermined frequency (in the following, referred to as a monopole mode).

Moreover, in the case illustrated in FIG. 7, the power feeding part 36 which, is a site where the power feeding element 21 feeds power to the radiating element 22 is located at a site other than a central portion 90 of the radiating element 22 between one end portion 22a and the other end portion 22b of the radiating element 22 (site between the central portion 90 and the end portion 22a or between the central portion 19 and the end portion 22b). In this way, when the power feeding part 36 is located at a site on the radiating element 22 other than the portion of the lowest impedance at the resonance frequency of the fundamental mode of the radiating element 22 (in this case, the central portion 90), it is possible to perform matching easily for the antenna structure 1. The power feeding part 36 is a site defined as a portion, which is the closest to the terminal end 12, of the conductor part of the radiating element 22 that is closest to the power leading element 21.

An impedance at a site on the radiating element 22 increases, in the case of the dipole mode, as the site is separated from the central portion 90 and approaches the end portion 22a of the end portion 22b. In the case of a coupling at high impedance in the electromagnetic field coupling, even if impedance between the power feeding element 21 and the radiating element 22 somewhat varies, an influence to the impedance matching is small, as long as the impedance at the coupling is greater than or equal to a predetermined value. Thus, in order to perform matching easily, the power feeding part 36 of the radiating element 22 is preferably located at a portion of the high impedance of the radiating element 22.

In the case of the dipole mode, for example, in order to perform an impedance matching of the antenna structure 1 easily, the power feeding part 36 may be located at a site separated from the portion of the lowest impedance at the resonance frequency of the fundamental mode of the radiating element 22 (in this case, the central portion 90) by a distance which is greater than or equal to one-eighth of an entire length of the radiating element 22 (preferably greater than or equal to one-sixth of the entire length, and more preferably greater than or equal to one-fourth of the entire length). In the case illustrated in FIG. 7, the entire length of the radiating element 22 corresponds to L7, and the power feeding part 36 is located on the end portion 22a side of the central portion 90.

In the case of the loop mode, for example, in order to perform an impedance matching of the antenna structure 1 easily, the power feeding part 36 may be located at a site within a region separated from the portion of the lowest impedance at the resonance frequency of the fundamental mode of the radiating element 22 by a distance which is less than or equal to one-sixteenth of a perimeter on an inner periphery side of the loop of the radiating element 22 (preferably less than or equal to one-twelfth of the perimeter, and more preferably less than or equal to one-eighth of the perimeter).

In the case of the monopole mode in which the end portion 22b is connected to the ground level of the terminal end 12, when the power feeding part 36, which is a site where the power feeding element 21 feeds power to the radiating element 22, is located at a site close to the end portion 22a side with respect to a portion of the lowest impedance at the resonance frequency of the fundamental mode of the radiating element 22 (in this case the end portion 22b), it is possible to easily perform an impedance matching of the antenna structure 1. Particularly, the power feeding part 36 is preferably located on the end portion 21a side of the central portion 90.

An impedance at a site on the radiating element 22 increases, in the case of the monopole mode in which the end portion 22b is connected to the ground level of the terminal end 12, as the site approaches the end portion 22a from the end portion 22b of the radiating element 22. In the case of a coupling at high impedance in the electromagnetic field coupling, even if impedance between the power feeding element 21 and the radiating element 22 somewhat varies, an influence to the impedance matching is small, as long as the impedance at the coupling is greater than or equal to a predetermined value. Thus, in order to perform matching easily, the power feeding part 36 of the radiating element 22 is preferably located at a portion of the high impedance of the radiating element 22.

In the case of the monopole mode in which the end portion 22b is connected to the ground level of the terminal end 12, for example, in order to perform the impedance matching of the antenna structure 1 easily, the power feeding part 36 may be located at a site separated from the portion of the lowest impedance at the resonance frequency of the fundamental mode of the radiating element 22 (in this case, the end portion 22b) by a distance which is greater than or equal to one-fourth of an entire length of the radiating element 22 (preferably greater than or equal to one-third of the entire length, and more preferably greater than or equal to a half of the entire length), and further preferably located on the end portion 22a side of the central portion 90.

Moreover, in the case where a wavelength radio wave in vacuum at the resonance frequency of the fundamental mode of the radiating element 22 is denoted by λ₀₁, the shortest distance D11 between the power feeding part 36 and the backlight chassis 8 is greater than or equal to 0.0034λ₀₁ and less than or equal to 0.21λ₀₁. The shortest distance D11 is more preferably greater than or equal to 0.0043λ₀₁ and less than or equal to 0.199λ₀₁, and further preferably greater than or equal to 0.0069λ₀₁ and less than or equal to 0.164λ₀₁. When the shortest distance D11 is set within the aforementioned regions, the antenna structure 1 has advantages that an actual gain of the radiating element 22 is enhanced. Moreover, because the shortest distance D11 is less than (λ₀₁/4), the antenna structure 1 does not generate circular polarization, but generates linear polarization.

Note that the shortest distance D11 refers to a distance connecting by a line between the closest portions of the power feeding part 36 and of the outer periphery part 8d, and the shortest distance D12 refers to a distance connecting by a line between the closest portions of the power feeding part 37 and the outer periphery part 8d. The outer periphery part 8d, in this case, is an outer periphery part of the backlight chassis 8 that is a ground level of the terminal end 12 connected to the power feeding element 21 for feeding power to the power feeding part 36. Moreover, the radiating element 22 and the backlight chassis 8 may be in the same plane, or may be in different planes. Moreover, the radiating element 22 may be arranged on a plane parallel to the plane on which the backlight chassis 8 is arranged, or may be arranged on a plane that intersects the plane of the backlight chassis 8 at an optional angle.

Moreover, in the case where a wavelength of a radio wave in vacuum at the resonance frequency of the fundamental of the radiating element 22 is denoted by λ₀₁, the shortest distance D21 between the power feeding element 21 and the radiating element 22 is preferably less than or equal to 0.2×λ₀₁ (more preferably less than or equal to 0.1×λ₀₁, and further preferably less than or equal to 0.05×λ₀₁). When the power feeding element 21 and the radiating element 22 are arranged separated by the aforementioned distance D21, the antenna structure 1 has an advantage in that an actual gain of the radiating element 22 is enhanced.

Note that the shortest distance D21 refers to a distance connecting by a line between the closest portions of the power feeding element 21 and of the radiating element 22. Moreover, the power feeding element 21 and the radiating element 22 may intersect each other or may not intersect viewed in a given direction as long as electromagnetic fields of the power feeding element 21 and the radiating element 22 are coupled to each other. The intersection angle may be an angle selected as suited. Moreover, the radiating element 22 and the power feeding element 21 may be in the same plane, or may be in different planes. Moreover, the radiating element 22 may be arranged on a plane parallel to the plane on which the power feeding element 21 is arranged, of map be arranged on a plane that intersects the plane of the power feeding element 21 at an angle selected as suited.

Moreover, a distance, in which the power feeding element 21 and the radiating element 22 run parallel to each other with the shortest distance D21, is preferably less than or equal to three-eighths of a physical length of the radiating element 22, in the case of the dipole mode. The distance is more preferably less than or equal to one-fourth of the physical length, and further preferably less than or equal to one-eighth of the physical length. In the case of the loop mode, the distance is preferably less than or equal to three-sixteenths of a perimeter on an inner periphery side of the loop of the radiating element 22. The distance is more preferably less than or equal to one-eighth of the perimeter, and further preferably less than or equal to one-sixteenth of the perimeter. In the case of the monopole mode, the distance is preferably less than or equal to three-fourths of a physical length of the radiating element 22. The distance is more preferably less than or equal to a half of the physical length, and further preferably less than or equal to one-fourth of the physical length.

Positions of the power feeding element 21 and the radiating element 22, which are the closest to each other with the shortest distance D21, are sites where the coupling between the power feeding element 21 and the radiating element 22 are strong. When the distance in which the power feeding element 21 and the radiating element 22 run parallel to each other is long, the power feeding element 21 is coupled to both a high impedance portion and a low impedance portion of the radiating element 22, and an impedance matching may not be made. Then, the power feeding element is strongly coupled only to the site at which variation of impedance is small. Thus a short distance in which the power feeding element 21 and the radiating element 22 run parallel to each other has an advantage in the impedance matching.

Moreover, an electric length that gives the fundamental mode of resonance of the power feeding element 21 is denoted by Le21, an electric length that gives the fundamental mode of resonance of the radiating element 22 in denoted by Le22, and a wavelength on the power feeding element 21 or the radiating element 22 at the resonance frequency f₁₁ of the fundamental mode of the radiating element 22 is denoted by λ₁. In the case where the fundamental mode of resonance of the radiating element 22 is the dipole mode, Le21 is preferably leas than or equal to (3/8)·λ₁ and Le22 is preferably greater than or equal to (3/8)·λ₁ and less than or equal to (5/8)·λ₁. In the case of the fundamental mode of resonance of the radiating element 22 being the loop mode, Le21 is preferably less than or equal to (3/8)·λ₁ and Le22 is preferably greater than or equal to (7/8)·λ₁ and leas than or equal to (9/8)·λ₁. In the case of the fundamental mode of resonance of the radiating element 22 being the monopole mode, Le21 is preferably less than or equal, to (3/8)·λ₁ and Le22 is preferably greater than or equal to (1/8)·λ₁ and less than or equal to (3/8)·λ₁.

Moreover, the backlight chassis 8 is formed so that the outer periphery part 8d is located along the radiating element. Then, the power feeding element 21 can form a resonance electric current (electric current distributed in a form of standing wave) on the power feeding element 21 and the backlight chassis 8 according to an interaction with the outer periphery part 8d, and performs an electromagnetic field coupling with the radiating element 22. Thus, a lower limit of the electric length Le21 of the power feeding element 21 does not particularly exist. The electric length Le21 may have a length sufficient to perform physically the electromagnetic field coupling with the radiating element 22.

Moreover, in the case of giving a degree of freedom to the shape of the power feeding element 21, the electric length Le21 is more preferably greater than or equal to (1/8)·λ₁ and less than or equal to (3/8)·λ₁, or greater than or equal to (1/8)·λ₂ less than or equal to (3/8)·λ₂, and particularly preferably greater than or equal to (3/16)·λ₁ and less than or equal to (5/16)·λ₁, or greater than or equal to (3/16)·λ₂ and less than or equal to (5/16)·λ₂. When the electric length Le21 falls within the aforementioned range, the power feeding element 21 resonates successfully at the designed frequency of the radiating element 22 (resonance frequency f₁₁), and a successful electromagnetic field coupling between the power feeding element 21 and the radiating element 22 can be obtained without depending on the backlight chassis 8, and it is preferable.

Moreover, in order to reduce the size of the antenna structure 1, the electric length Le21 of the power feeding element 21 is more preferably less than (1/4)·λ₁ or less than (1/4)·λ₂, and particularly preferably less than or equal to (1/8)·λ₁ or less than or equal to (1/8)·λ₂.

Note that a state in which an electromagnetic field coupling realized means a state in which a matching is made. Moreover, in this case, the electric length of the power feeding element it not required to be designed it conformity to the resonance frequency f₁₁ of the radiating element 22, and the power feeding element 21 can be designed freely as a radiating conductor. Thus, multi-frequency of the antenna structure 1 can be easily realized.

Note that in the case where the power feeding element 21 does not include a matching circuit or the like, a physical length L21 of the power feeding element 21 (in FIG. 7, corresponding to L6+L8) is determined by a wavelength λ_{g1}=λ₀₁·k₁, where λ₀₁ is a wavelength of a radio wave in vacuum at a resonance frequency of the fundamental mode of the radiating element 22 and k₁ is a shortening rate of a wavelength shortening effect by an environment in which the power feeding element 21 is implemented. Here, k₁ is a value calculated from a specific permittivity, a specific permeability and a thickness of a medium (environment) of a dielectric base material in which the power feeding element 21 is arranged, such as an effective specific permittivity (εᵣ₁) and an effective specific permeability (μᵣ₁) of an environment of the power feeding element 21, a resonance frequency, or the like. That is, the physical length L21 is less than or equal to (3/8)·λ_{g1}. Note that the shortening rate may be calculated from the aforementioned physical properties, or may be obtained by on actual measurement. For example, the shortening rate may be calculated from a difference between resonance frequencies, obtained by measuring a resonance frequency of a target element arranged in an environment, in which the shortening rate is desired to be measured, and obtained by measuring a resonance frequency of the same element in an environment in which shortening rates of respective selected frequencies are known.

The physical length L21 of the power feeding element 21 is a physical length that gives an electric length Le21, and is equal to Le21 in an ideal case that does not include other element. In the case where the power feeding element 21 includes a matching circuit or the like, the physical length L21 is preferably greater than zero and less than or equal to Le21. The physical length L21 can be made shorter (a size can be reduced) by using a matching circuit such as an inductor. The physical length L21 is shorter than the entire length of the radiating element 22.

Moreover, in the case where the fundamental mode of resonance of the radiating element 22 is the dipole mode (the radiating element 22 is a linear conductor where both ends are open ends), the electric length Le22 is preferably greater than or equal to (3/8)·λ₁ and less than or equal to (5/8)·λ₁, more preferably greater than or equal to (7/16)·λ₁ and less than or equal to (9/16)·λ₁, and particularly preferably greater than or equal to (15/32)·λ₁ and less than or equal to (17/32)·λ₁. Moreover, taking into account a higher order mode, the electric length Le22 is preferably greater than or equal to (3/8)·λ₁·m and less than or equal to (5/8)·λ₁·m, more preferably greater than or equal to (7/16)·λ₁·m and less than of equal to (9/16)·λ₁·m, and particularly preferably greater than or equal to (15/32)·λ₁·m and less than or equal to (17/32)·λ₁·m.

In the aforementioned ranges, m represents a mode number of the higher order mode, and is a natural number. The number m is preferably an integer of 1 to 5, and particularly preferably an integer of 1 to 3. The case with m of one is a case of the fundamental mode. When the electric length Le22 falls within the aforementioned range, the radiating element 22 fully functions as a radiating conductor, and an efficiency of the antenna structure 1 is excellent and is preferable.

Moreover, similarly, in the case where the fundamental mode of resonance of the radiating element 22 is the loop mode (the radiating element 22 is a loop conductor) the electric length Le22 is preferably greater than or equal to (7/8)·λ₁ and less than of equal to (9/8)·λ₁, more preferably greater than or equal to (15/16)·λ₁ and less than or equal to (17/16)·λ₁, and particularly preferably greater than or equal to (31/32)·λ₁ and less than of equal to (33/32)·λ₁. Moreover, for a higher order mode, the electric length Le22 is preferably greater than or equal to (7/8)·λ₁·m and less than or equal to (9/8)·λ₁·m more preferably greater than or equal to (15/16)·λ₁·m and leas than or equal to (17/16)·λ₁·m, and particularly preferably greater than of equal to (31/32)·λ₁·m and less than or equal to (33/32)·λ₁·m. When the electric length Le22 falls within the aforementioned range, the radiating element 22 fully functions as a radiating conductor, and an efficiency of the antenna structure 1 is excellent and it is preferable.

Moreover, similarly, in the case where the fundamental mode of resonance of the radiating element 22 is the monopole mode (the radiating element 22 is connected to the ground level of the terminal end 12 and has an open end), the electric length Le22 is preferably greater than or equal to (1/8)·λ₁and less than or equal to (3/8)·λ₁, more preferably greater than or equal to (3/16)·λ₁ and less than of equal to (5/16)·λ₁, and particularly preferably greater than or equal to (7/32)·λ₁ and less than or equal to (9/32)·λ₁. When the electric length Le22 falls within the aforementioned range, the radiating element 22 fully functions radiating conductor, and an efficiency of the antenna structure 1 is excellent and it is preferable.

Note that the physical length L22 of the radiating element 22 is determined by a wavelength λ_{g2}=λ₀₂·k₂, where λ₀₁ is a wavelength of a radio wave in vacuum at a resonance frequency of the fundamental mode of the radiating element 22 and k₂ is a shortening rate of a wavelength shortening effect by an environment in which the radiating element 22 is implemented. Here, k₂ is a value calculated from a specific permittivity, a specific permeability and a thickness of a medium (environment) of a dielectric base material in which the radiating element 22 is arranged, such as an effective specific permittivity (εᵣ₂) and an effective specific permeability (μᵣ₂) of an environment of the radiating element 22, a resonance frequency, or the like. That is, in the case where the fundamental mode of resonance of the radiating element 22 is the dipole mode, the physical length L22 is ideally (1/2)·λ_{g2}. The length L22 of the radiating element 22 is preferably greater than or equal to (1/4)·λ_{g2} and less than or equal to (3/4)·λ_{g2}, and further preferably greater than or equal to (3/8)·λ_{g2} than or equal to (5/8)·λ_{g2}. In the case where the fundamental mode of resonance of the radiating element 22 is the loop mode, the length L22 is greater than or equal to (7/8)·λ_{g2} and less than or equal to (9/8)·λ_{g2}. In the case where the fundamental mode of resonance of the radiating element 22 is the monopole mode, the length L22 is greater than or equal to (1/8)·λ_{g2} and less than or equal to (3/8)·λ_{g2}.

The physical length of the radiating element 22 is a physical length that gives an electric length Le22, and is equal to Le22 in an ideal case that does not include another element. The length L22 is, even if L22 is made shorter by using a matching circuit such as an inductor, preferably greater than zero and less than or equal to Le22, and particularly preferably greater than or equal to 0.4 times Le22 and less than or equal to Le22. When the length L22 of the radiating element 22 is adjusted to the aforementioned length, the radiating element 22 has an advantage in enhancing an operation gain of the radiating element 22.

Moreover, in the case where an interaction between the power feeding element 21 and the outer periphery part 8d of the backlight chassis 8 can be used, as illustrated in FIG. 6, the power feeding element 21 may function as a radiating conductor. The radiating element 22 is a radiating conductor that functions, for example, as a λ/2 dipole antenna, when the radiating element 22 is fed power by the power feeding element 21 at the power feeding part 36 in a noncontact manner through an electromagnetic field coupling. The power feeding element 21 is a linear power feeding conductor that can feed power to the radiating element 22, but is also a radiating conductor that can function as a monopole antenna (e.g. λ/4 monopole antenna) when the power feeding element 21 is fed power at the terminal end 12. When the resonance frequency of the radiating element 22 is set to f₁₁, the resonance frequency of the power feeding element 21 is set to f₂, and the length of the power feeding element 21 is adjusted as a monopole antenna that resonates at the frequency f₂, the radiating function of the power feeding element 21 can be used, and the multi-frequency of the antenna structure 1 can be easily realized.

In the case where the power feeding element 21 does not include a matching circuit or the like, the physical length L21 of the power feeding element 21, when the radiating function of the power feeding element 21 is used, is determined by a wavelength λ_{g3}=λ₃·k₁, where λ₃ is a wavelength of a radio wave in vacuum at a resonance frequency f₂ of the power feeding element 21 and k₁ is a shortening rate of a wavelength shortening effect by an environment in which the power feeding element 21 is implemented. Here, k₁ is a value calculated from a specific permittivity, a specific permeability and a thickness of a medium (environment) of a dielectric base material in which the power feeding element 21 is arranged, such as an effective specific permittivity (εᵣ₁) and an effective specific permeability (μᵣ₁) of an environment of the power feeding element 21, a resonance frequency, or the like. That is, the length L21 is greater than or equal to (1/8)·λ_{g3} and less than or equal to (3/8)·λ_{g3}, and preferably greater than or equal to (3/16)·λ_{g3} and less than or equal to (5/16)·λ_{g3}.

A resonance frequency of the fundamental mode of the power feeding element is f₂₁, a resonance frequency of the second order mode of the radiating element is f₃₂, a wavelength in vacuum at the resonance frequency of the fundamental mode of the radiating element is λ₀, a value obtained by normalizing the shortest distance between the power feeding element and the radiating element by λ₀ is x. According to the antenna structure of the embodiment, when the frequency ratio p (=f₂₁/f₃₂) is greater than or equal to 0.7 and less than or equal to (0.1801˜x^{-0.468}), an excellent matching can be made at the resonance frequency of the fundamental mode of the radiating element and at the resonance frequency of the second order mode.

For example, in the case of the antenna structure 1, when the resonance frequency of the fundamental mode of the power feeding element 21 is f₂₁, and resonance frequency of the second order mode of the radiating element 22 is f₁₁₂, when the frequency ratio p (=f₂₁/f₁₁₂) is greater than or equal to 0.7 and less than or equal to (0.1801·x^{-0.468}), an excellent matching can be made at the resonance frequency of the fundamental mode of the radiating element and at the resonance frequency of the second order mode.

FIG. 8 is a diagram depicting an example of a positional relationship among the respective compositions of the analysis model illustrated in FIG. 6. A TFT glass substrate 4b corresponds to a glass substrate, on which thin film transistors (TFT) are formed, that is a pair of glass substrates sandwiching a liquid crystal in the liquid crystal panel 4. The radiating element 22 is arranged on a front surface of the TFT glass substrate 4b (display surface of the liquid crystal panel 4), and the power feeding element 21 is arranged on a rear surface of the TFT glass substrate 4b.

Next, results of analysis for the S11 characteristic of the antenna structure 1 will be described.

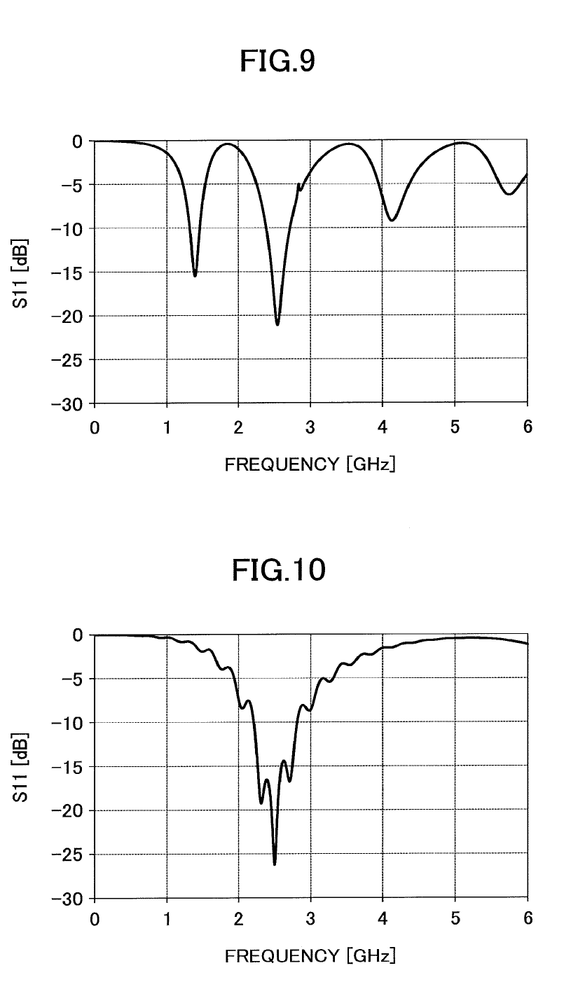

FIG. 9 is an S11 characteristic diagram for the antenna structure 1, and FIG. 10 is an S11 characteristic diagram for an antenna structure obtained by excluding the radiating element 22 from the antenna structure 1 (antenna structure including only the power feeding element 21).

Respective dimensions shown in FIGS. 6 to 8 when the measurement illustrated in FIGS. 9 and 10 was performed were as follows (in units of mm),
L1: 498,
L2: 8,
L4: 884,
L6: 4,
L7: 50,
L8: 10,
L9, 8, and
L10: 5.
   External dimensions of backlight chassis 8 were the same an external dimensions of the liquid crystal panel 4 (vertical: L1, and horizontal: L4). A thickness of the TFT glass substrate 4b on the rear surface side of the liquid crystal panel 4 was 0.5 mm.

With the illustrations in FIGS. 9 and 10, it can be seen that the antenna structure 1 functions as a multi-band, antenna that is excited at the resonance frequencies f₁ of the fundamental mode of the radiating element 22, and includes the power feeding element 21 that excites at the resonance frequency f₂₁.

FIG. 11 is an S11 characteristic diagram for the antenna structure 1 when the length L7 of the radiating element 22 varied. Curves with labels of L7a, L7b and L7c illustrate results with the lengths L7 of 50 mm, 60 mm and 70 mm, respectively. Dimensions other than the dimension L7 were the same as those when the measurement illustrated in FIG. 9 was performed. As illustrated in FIG. 11, even if the length of the radiating element 22 is changed, the antenna structure 1 functions as a multi-band antenna.

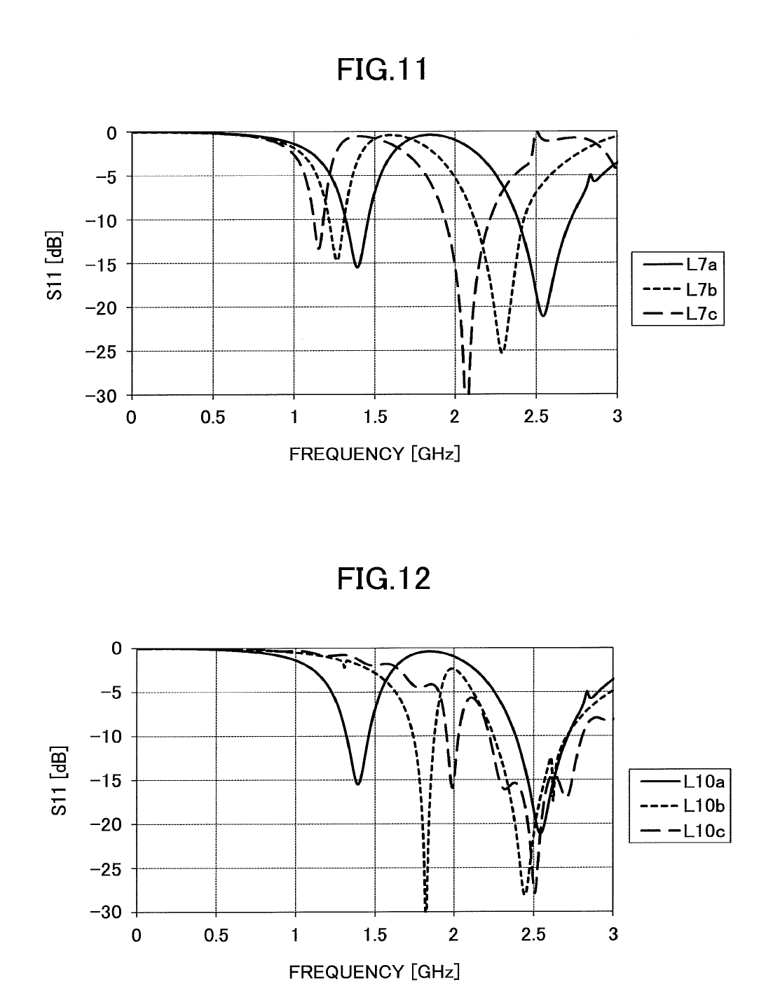

FIG. 12 is an S11 characteristic diagram for the antenna structure 1 when a position of the radiating element 22 (i.e. length L10 indicated in FIG. 7) is changed. The length L10 indicates a distance between the tip portion 21b of the power feeding element 21 and the end portion 22a of the radiating element 22. A positive value of the length L10 means that the power feeding element 21 and the radiating element 22 overlap with each other in a planar view in the X-Y plane. A negative value of the length L10 means that the power feeding element 21 does not overlap with the radiating element 22 in the X-Y planar view (i.e. the end portion 22a is located on the right of the end portion 21b). Curves with labels of L10a, L10b and L10c illustrate results with the lengths L10 of 0 mm, −5 mm and −7 mm, respectively. Dimensions other than the dimension L10 were the same as those when the measurement illustrated in FIG. 9 was performed. As illustrated in FIG. 12, even if the position of the radiating element 22 is changed, the antenna structure 1 functions as a multi-band antenna.

As described above, the antenna structure and the electronic device have been described by the embodiments. The present invention is not limited to the embodiments. Various variations and enhancements, such as combination/replacement with/by a part or a whole of the other embodiment may be made without departing from the scope of the present invention.

For example, the power feeding element 21 may feed power to the radiating element 22 in a noncontact manner according to a capacitance coupling or an electromagnetic coupling with the radiating element 22.

For example, a plurality of antenna structures may be installed in an electronic device.

### REFERENCE SIGNS LIST

1 antenna structure
2 electronic device
3 frame
3a front surface part
3b side surface part
3c rear surface part
4 liquid crystal panel
5 front surface panel
6 light guide plate
7 light source
8 backlight chassis
8a bottom surface part
9 backlight unit
10 circuit module
11 transmission line
12 terminal end
13 coaxial cable
14 core wire
15 outer conductor
16 connection conductor
17 tip
18 intermediate portion
19 display panel
21 power feeding element
22 radiating element

What is claimed is:

1. An antenna structure, comprising:
a radiating element;
a power feeding element configured to feed power to the radiating element in a noncontact manner;
a backlight chassis, on which a light source for generating light is attached, a liquid crystal panel being irradiated with the light; and
a transmission line conductably connected to the backlight chassis, the power feeding element being connected to an end of the transmission line.

2. The antenna structure according to claim 1,
wherein a tip of the power feeding element is an open end.

3. The antenna structure according to claim 1,
wherein the power feeding element is shunted to the backlight chassis.

4. The antenna structure according to claim 1,
wherein a tip of the power feeding element is shunted to an intermediate portion of the power feeding element.

5. An electronic device, comprising:
a radiating element;
a power feeding element configured to feed power to the radiating element in a noncontact manner;
a liquid crystal panel;
a backlight chassis, on which a light source for generating light is attached, the liquid crystal panel being irradiated with the light; and
a transmission line conductably connected to the backlight chassis, the power feeding element being connected to an end of the transmission line.
